(19) United States
(12) Patent Application Publication
(10) Pub. No.: US 2023/0202810 A1
(43) Pub. Date: Jun. 29, 2023

(54) WINCH ASSEMBLY FOR ASSISTING THE MOVEMENT OF A TRACKED VEHICLE AND RELATIVE CONTROL METHOD

(71) Applicant: PRINOTH S.P.A., Vipiteno (IT)

(72) Inventor: Alberto Paoletti, Vipiteno (IT)

(21) Appl. No.: 18/080,396

(22) Filed: Dec. 13, 2022

(30) Foreign Application Priority Data
Dec. 24, 2021 (IT) 102021000032639

(51) Int. Cl. B66D 1/48; B66D 1/08

(52) U.S. Cl. CPC B66D 1/485; B66D 1/08; B66D 1/38

(57) ABSTRACT

A winch assembly including a winch control device coupled to an actuator assembly to control a winding and unwinding of a cable and configured to provide a first control signal indicative of a desired pump pressure of the actuator assembly and/or the second control signal indicative of a desired pump displacement of the actuator assembly, and determine the first control signal and/or the second control signal based on: a measured travel speed signal indicating the measured travel speed of a tracked vehicle; a measured pressure signal indicative of a measured pressure in a high pressure branch of a hydraulic circuit of the actuator assembly; and one or more signals of: rope speed signal, wound rope length signal, desired pull force signal manually set by an operator, measured angle signal of an arm of the winch assembly with respect to a travel direction.

### PRIORITY CLAIM

This application claims the benefit of and priority to Italian Patent Application No. 102021000032639, filed on Dec. 24, 2021, the entire contents of which is incorporated herein by reference.

### TECHNICAL FIELD

The disclosure relates to a winch assembly for assisting the movement of a tracked vehicle, in particular a snow groomer, along steep slopes and to the relative control method.

In particular, a tracked vehicle comprises a frame; a vehicle control unit; and the winch assembly, which, in turn, comprises a support structure; a rotary drum, which can rotate relative to the support structure; a cable, which can be wound and unwound around the drum; an actuator assembly, which is coupled to the drum so as to cause the drum to rotate around the axis; and a winch control device, which is coupled to the actuator assembly to control the actuator assembly to adjust the winding and unwinding of the cable.

### BACKGROUND

Generally speaking, certain tracked vehicles, such as a snow groomer, comprises a tiller to process a snowpack of ski slopes and a shovel to move snow masses along ski slopes.

When the tracked vehicle operates on a ski slope, particularly relatively steep slopes, a free end of a cable of the winch assembly is fixed to an upstream anchorage. Operating the tracked vehicle with the help of the winch assembly ensures relatively greater safety as well as prevents the tracked vehicle from skidding in case it loses its grip on the snow surface.

EP Patent Document No. 1 118 580 discloses a method to control the winch assembly so that the pull force of the cable changes depending on the difference in pressure values between the two pumps supplying the tracks of the snow groomer and on the angle of the arm of the winch relative to the travel direction. This control method works well within some limits, but is not very appropriate in case relatively short reaction times are requested and a relatively strong resistance to internal and external disturbances is needed.

### SUMMARY

An object of the disclosure is to provide a winch assembly capable of overcoming at least one of the drawbacks of certain of the prior art.

According to the disclosure, there is provided a winch assembly including a support structure; a drum rotatable relative to the support structure; a cable wrapped around the drum; and an actuator assembly coupled to the drum and configured to receive at least one of: a first control signal indicative of a desired pump pressure of the actuator assembly, and a second control signal indicative of a desired pump displacement of the actuator assembly. The winch assembly also includes a winch control device coupled to the actuator assembly and configured to: control, via the actuator assembly, a winding and an unwinding of the cable, and determine at least one of the first control signal and the second control signal based on at least one of: a measured travel speed signal indicating a measured travel speed of a tracked vehicle, a measured pressure signal indicative of a measured pressure of a high pressure branch of a hydraulic circuit of the actuator assembly, and at least one signal of: a cable speed signal, a wound cable length signal, an operator set desired pull force signal, a measured angle signal of an arm of the winch assembly relative to a forward direction, and a calculated pull force signal indicating a calculated pull force. In accordance with this disclosure, the winch assembly ensures precision in the control of the pull force even for relatively high pull force values as well as relatively short reaction times. Such a configuration counters relatively sudden external load changes due to relatively sudden changes in the ground or to relatively sudden changes in the load of the tracked vehicle. Moreover, the winch assembly is relatively insensitive to internal or external disturbances in the control of the pull force of the winch and provides a pull force control system having relatively quick and stable dynamics. In more detail, in accordance with the present disclosure, the control of the pull force is capable of relatively quickly reacting to operator's commands and/or to load changes due to external causes.

In accordance with the present disclosure, the first control signal involved in the adjustment of the pull force of the winch assembly is a signal controlled in open loop relative to the pull force. By doing so, a load cell is no longer needed like in certain of the prior art and this avoids potential oscillations or instabilities of the control system. Such a configuration also makes the control system relatively more simple, economic and intrinsically sturdy.

In accordance with the present disclosure, the pull force is adjusted based on the pull direction and on the travel direction, in particular the pull force is limited in some circumstances.

In accordance with the present disclosure, the control device ensures a relatively more precise, quick and stable adjustment of the pull force, with the value of the wound rope length enabling a relatively better adjustment of the torque to be applied to the drum to determine a pull force.

According to certain embodiments, the winch assembly comprises a variable displacement motor coupled to the hydraulic circuit and supplied by the variable displacement pump through the hydraulic circuit; the variable displacement motor being configured to vary its displacement based on the pressure detected on the hydraulic circuit.

Another object of the disclosure is to provide a tracked vehicle capable of reducing the drawbacks of certain of the prior art.

According to the disclosure, there is provided a tracked vehicle comprising an engine assembly, such as an internal combustion engine, a first and second track and a winch assembly as disclosed herein.

Another object of the disclosure is to provide a method for operating a winch assembly for a tracked vehicle capable of reducing at least one of the drawbacks of certain of the prior art.

According to the disclosure, there is provided a method of controlling a winch assembly of a tracked vehicle, the winch assembly comprising a rotatable drum, a cable wrapped around the drum, an actuator assembly coupled to the drum, comprising a variable displacement pump and a hydraulic motor and configured to wind and unwind the cable. The method of this embodiment includes controlling the pressure exiting the variable displacement pump to control at least one of the winding and unwinding of the cable and the displacement of the variable displacement pump to control the winding and unwinding of the cable based on the measured travel speed of the tracked vehicle, a pressure value measured on a high pressure branch of a hydraulic circuit of the actuator assembly, and at least one value of: a cable speed, a wound cable length, an operator set desired pull force, and a measured angle of the arm of the winch assembly relative to a direction of travel.

### BRIEF DESCRIPTION OF THE DRAWINGS

Other features and advantages of the disclosure will be best understood upon perusal of the following description of a non-limiting embodiment thereof, with reference to the accompanying drawing, wherein:

FIG. 1 is a side elevation view, with parts removed for greater clarity, of a tracked vehicle comprising a winch assembly according to the disclosure;

FIG. 2 is a diagram of a detail of the winch assembly of FIG. 1; and

FIG. 3 is a diagram of a detail of the winch assembly of FIG. 1.

### DESCRIPTION OF EMBODIMENTS

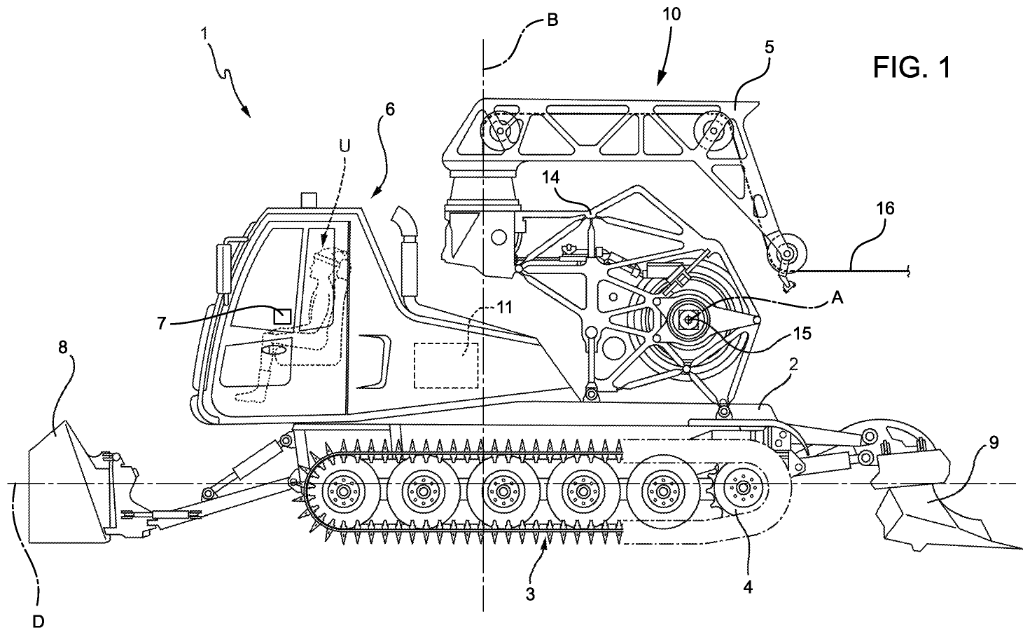

With reference to FIG. 1, number 1 defines, as a whole, a tracked vehicle. In certain embodiments, the tracked vehicle 1 is a snow groomer configured to prepare ski slopes.

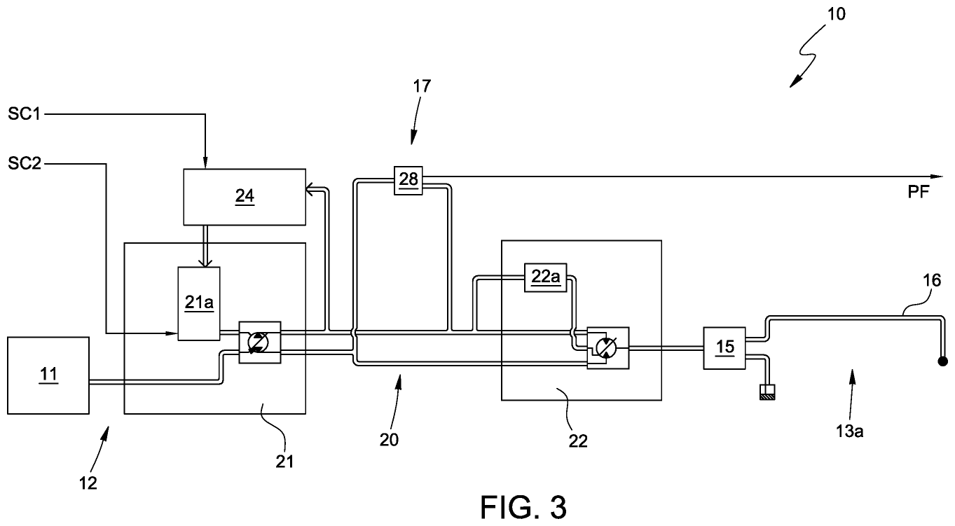

The tracked vehicle 1 comprises a frame 2; two tracks 3 (only one of them is shown in FIG. 1); two drive wheels 4 (only one of them is shown in FIG. 1), which are operatively coupled to the respective tracks 3; a cabin 6; a user interface 7 arranged in the cabin 6; a shovel 8, which is supported by the frame 2 at the front; a tiller 9, which is supported by the frame 2 at the back; a winch assembly 10, which is fixed to the frame 2; an engine assembly 11; and a powertrain 12 (partially visible in FIG. 3), which is operatively connected to the engine assembly 11, to the drive wheels 4, to the shovel 8, to the miller 9. Furthermore, the powertrain 12 connects the engine assembly 11 to the winch assembly 10.

In an optional embodiment, the tracked vehicle 1 comprises either the shovel 8 or the tiller 9. In other words, either the shovel 8 or the tiller 9 can be left out.

In certain embodiments, the engine assembly 11 comprises an internal combustion engine. In another embodiment, the engine assembly 11 comprises one or more electric machines and, in certain instances, power supply batteries. In another embodiment, the engine assembly 11 comprises one or more electric machines and at least one internal combustion engine, so as to form a hybrid engine assembly 11 of the series or parallel kind or of another kind. In another embodiment, the engine assembly 11 comprises fuel cells and one or more electric motors.

The powertrain 12 can be hydraulic or electric or a combination of hydraulic and electric.

The tracked vehicle 1 comprises a vehicle control unit 13, which is connected to the user interface 7 and is configured to control the tracked vehicle 1.

With reference to FIG. 3, the winch assembly 10 comprises a winch control device 13a configured to control the winch assembly 10. Furthermore, the winch control device 13a is connected to the user interface 7.

In certain embodiments, the tracked vehicle 1 comprises a first pump (not visible in the figures) to operate one of the tracks 3 and a second pump (not visible in the figures) to operate the other track 3.

In another embodiment, the tracked vehicle 1 comprises a first electric machine to operate one of the tracks 3 and a second electric machine to operate the other track 3.

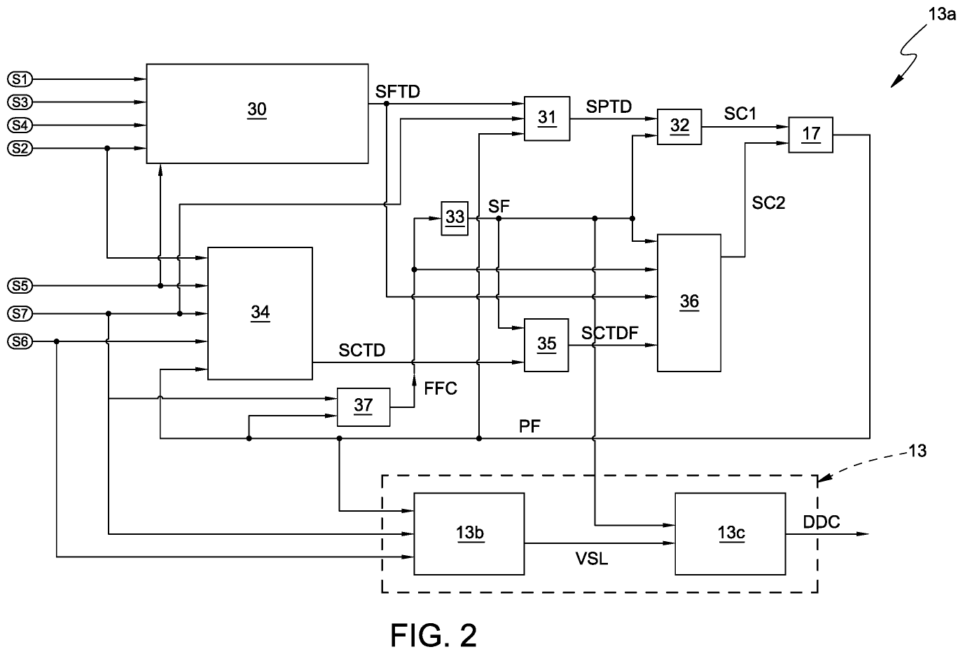

With reference to FIGS. 1 and 2, the winch assembly 10 comprises a support structure 14, which is fixed to the frame 2, a rotary drum 15, which can rotate relative to the support structure 14 around an axis A; a cable 16, which has an end fixed to the drum 15 and is wound around the drum 15; an actuator assembly 17 (FIG. 3) coupled to the drum 15 so as to wind or unwind the cable 16 through a pull force; and the winch control device 13a coupled to the actuator assembly 17 to control the pull force of the cable 16.

The winch control device 13a is configured to determine and emit a first control signal SC1 and a second control signal SC2 to control the actuator assembly 17.

The actuator assembly 17 is configured to receive the first control signal SC1 and the second control signal SC2 from the winch control device 13a and to be controlled by the winch control device 13a through the first control signal SC1 and the second control signal SC2.

With reference to FIG. 3, the actuator assembly 17 comprises a hydraulic circuit 20, a variable displacement pump 21 which supplies the hydraulic circuit, and a variable displacement motor 22 which is supplied by the variable displacement pump 21 through the hydraulic circuit 20.

The actuator assembly 17 comprises a hydraulic shutter valve 24, whose inlet is connected to the high-pressure branch of the hydraulic circuit. Furthermore, the shutter valve 24 is connected to the winch control device 13a so as to receive and be controlled by the first control signal SC1. The shutter valve adjusts its outlet based on the first control signal SC1.

The variable displacement pump 21 comprises a pump control unit 21a to change its displacement. The pump control unit 21a comprises a hydraulic input connected to the outlet of the shutter valve 24 and an electric input configured to receive an electric signal and connected to the winch control device 13a to receive the second control signal C2. In more detail, the pump control unit 21a is configured to vary the displacement of the variable displacement pump 21 based on the pressure values received through the hydraulic input and on the value of the electric signal received by the electric input. In more detail, the pump control unit 21a adjusts the displacement of the variable displacement pump 21 based on the smaller value between the pressure value and the value of the electric signal.

In an alternative embodiment, the second control signal SC2 is omitted or has a fixed value always equal to the maximum value possible. In this case, the pump control unit 21a adjusts the displacement of the variable displacement pump 21 based on the pressure value received by the hydraulic input.

In another alternative embodiment, the first control signal SC1 is omitted or has a fixed value always equal to the maximum value possible. In this case, the pump control unit 21a adjusts the displacement of the variable displacement pump 21 based on the displacement value received indicated by the second control signal SC2.

The variable displacement motor 22 comprises a motor control unit 22a, which is configured to adjust the displacement of the variable displacement motor 22. The motor control unit 22a is connected to the high pressure branch of the hydraulic circuit 20 as to receive, as an input, the liquid under pressure and adjust the displacement of the variable displacement motor 22 based on the pressure of the high pressure branch of the hydraulic circuit 20. In other words, the variable displacement motor 22 is configured to vary its displacement based on the pressure of the high pressure branch of the hydraulic circuit 20. The pressure of the hydraulic circuit, as discussed above, is adjusted depending on the first control signal SC1. As a consequence, the variable displacement motor 22 is configured to vary its displacement based on the first control signal SC1.

The variable displacement motor 22 is coupled to the drum 15 and acts upon the drum 15 to adjust the pull force of the rope 16.

The user interface 7 is coupled to the winch control device 13a and enables a desired force control, which is received from the operator U, to be sent. In more detail, the user interface 77 is configured to emit a desired force signs S4 based on the desired force control received from the operator U.

The winch control device 13a comprises a pressure sensor 28, which is coupled to the high pressure branch of the hydraulic circuit 20 to detect the pressure of the hydraulic circuit 20 and emit a measured pressure signal PF, which is an electric signal indicative of the pressure of the high pressure branch of the hydraulic circuit 20.

The tracked vehicle 1 comprises a speed sensor (not shown in the figures) to measure the travel speed of the tracked vehicle 1. The speed sensor is coupled to the winch control device 13a to determine and send to the winch control device 13a a measured travel speed signal S2 indicative of the measured travel speed.

The winch assembly 10 comprises a rope speed sensor (not shown in the figures) coupled to rope 16 to measure the moving speed of the rope 16 and determine a measured rope speed signal S3 indicative of the measured rope speed S3 to be sent to the winch control device 13a. In another embodiment of the disclosure, the rope speed sensor is coupled to the drum, measures the rotations of the drum and sends the number of rotations of the drum to the winch control device.

The winch assembly 10 comprises a wound rope sensor coupled to the rope to measure the quantity of rope wound around the drum. The wound rope sensor determines and sends to the winch control device a rope a measured wound rope length signal S7. In another embodiment, the wound rope sensor comprises a calculation unit, which calculates the quantity of wound rope based on the number of positive or negative revolutions of the drum. The sensor detecting the revolutions of the drum can be part of the wound rope sensor or be a separate sensor.

The winch assembly 10 comprises an angle sensor coupled to an arm 5 of the winch assembly 10 to measure the angle formed by the arm 5 of the winch assembly 10 with a travel direction D of the tracked vehicle. The angle sensor determines and sends to the winch control device 13a a measured angle signal S5. In particular, the arm 5 is fixed to the support structure 14 and can rotate around a vertical axis B. The arm 5 is coupled to the drum 15 and guides the rope 16.

The tracked vehicle 1 comprises a pressure sensor (not shown in the figures) coupled to the first and to the second pump (not shown) of the one of the tracks 3 and of the other track 3, respectively, in particular coupled to the hydraulic circuit of the first pump and to the hydraulic circuit of the second pump. The pressure sensor is configured to define a measured track pressure signal S1 indicative of the pressure difference between the two hydraulic circuits of the two tracks 3.

The track pressure signal S1, the measured travel speed signal S2, the rope speed signal S3, the desired force signal S4, the measured angle signal S5, the wound rope length signal S7, the measured pressure signal PF are electric signals.

The winch control device 13a is configured to determine the first and the second control signal SC1 and SC2 based on the measured travel speed signal S2 of the tracked vehicle 1, on the measured pressure signal PF, on the rope speed signal S3, on the wound rope length signal S7, on the measured angle signal S5 and on the desired force signal S4.

In more detail, the winch control device 13a defines the first control signal SC1 based on the measured angle signal S5, on the rope speed signal S3, on the wound rope signal S7, on the measured travel speed signal S2, on the measured pressure signal PF and on the desired pull force signal S4.

Furthermore, the winch control device 13a defines the first control signal SC1 based on the track pressure signal S1.

With reference to FIG. 2, the winch control device 13a defines the second control signal SC2 based on the measured angle signal S5, on the wound rope signal S7, on the measured travel speed signal S2, on the measured pressure signal PF, on the rope speed signal S3 and, such as, on the desired pull force signal S4 and/or on the track pressure signal S1.

Furthermore, the tracked vehicle 1 comprises an engine revolution sensor coupled to the engine assembly 11 and defining a measured engine revolution signal S6 indicative of a number of measured revolutions of the engine assembly 11 of the tracked vehicle 1. The engine revolution signal S6 is an electric signal.

In certain, though non-limiting, embodiments of the disclosure, the winch control device 13a defines the second control signal SC2 based on the engine revolution signal S6 in addition to the signals indicated above.

In an alternative embodiment, one or more of the signals listed above are omitted in the determination of the control signal SC1 and of the second control signal SC2 by the winch control device 13a.

In an alternative embodiment, the winch control device 13a does not define the second control signal SC2 or the winch control device defines the second control signal with a fixed and non-variable value based on the signals listed above. In this case, the winch control device 13a defines the second control signal SC2 as equal to the maximum possible value of the control signal SC2.

The two alternative embodiments described above can be combined with one another. In other words, an embodiment of the disclosure comprises a winch control device 13a which only determines the first control signal SC1 in the ways discussed above.

In an alternative embodiment, the winch control device 13a does not define the first control signal SC1 or the winch control device defines the first control signal with a fixed and non-variable value based on the signals listed above. In this case, the winch control device 13a defines the first control signal SC1 as equal to the maximum possible value of the control signal SC1.

The alternative embodiments described above can be combined with one another; in other words, an embodiment of the disclosure comprises a winch control device 13a which only determines the second control signals SC2 in the ways discussed above.

In certain, though non-limiting, embodiments of the disclosure, the winch control device 13a determines the first and/or the second control signals SC1 and SC2 according to the following paragraphs.

The winch control device 13a comprises a calculation unit 30 configured to calculate a desired theoretical force signal SFTD indicative of a desired theoretical pull force value. The control unit 30 receives, as an input, the measured angle signal S5, the rope speed signal S3, the desired pull force signal S4, the measured travel speed signal S2 and defines the desired theoretical force signal SFTD based on the input signals.

In another embodiment, the calculation unit 30 receives, as an input, the track pressure signal S1 and defines the desired theoretical force signal SFTD also based on said signal together with the signals listed above.

The winch control device 13a comprises a calculation unit 31 connected to the calculation unit 30. The calculation unit 31 receives, as an input, the desired theoretical force signal SFTD, the wound rope signal S7 and the measured pressure signal PF and determines a desired theoretical pressure signal SPTD.

The winch control device 13a comprises a frequency-adjustable active filter 32 and an oscillation detector 33 configured to receive, as an input, a calculated pull force signal FFC and to provide, as an output, a filtering signal SF indicative of one or more frequency values, if an oscillation on the calculated force signal FFC is detected. The oscillation detector 33 is configured to detect oscillations through the detection of frequencies related to harmonics having amplitude values greater than a given or designated value and within a first detection frequency range. To this aim, the oscillation detector 33 can perform a FFT or a DFT or be equipped with other electronic means to detect harmonics exceeding a given ore designated amplitude and within a first detection frequency range.

In particular, the calculated pull force signal FFC is calculated based on the wound rope length signal S7 and on the measured pressure signal PF.

The calculated pull force signal FFC is an electric signal. In other words, according to the disclosure, the snow groomer 1 does not comprise a force sensor, in particular a load cell, coupled to the rope 16 to detect the pull force exhibited by the rope 16, but the pull force is calculated through the wound rope length signal S7 and the measured pressure signal PF.

In more detail, the winch control device 13a comprises a control unit 37, which receives, as an input, the wound rope length signal S7 and the measured pressure signal PF and provides, as an output, a calculated pull force signal FFC indicative of the pull force on the rope 16.

Such a configuration eliminates certain of the problems caused by the measurement of the pull force through a force sensor, in particular a lead cell, as well as the oscillations of said measurement, which, in certain of the prior art, can cause instability in the feedback of the control of the pull force. Such a calculation of the pull force instead of the measurement provides that the control system is relatively more stable and does not cause oscillations or instability in the controlled system. In other words, in accordance with the present disclosure, a relatively complete control of the pull force is obtained without the disadvantages of the feedback on the control of the pull force.

The active filter 32 is frequency-adjusted based on the frequency or on the frequencies detected by the oscillation detector 33 so as to dampen or eliminate oscillations in the measured pressure PF or in the calculated pull force FFC. To this aim, the active filter 32 receives, as an input, the filtering signal SF and the desired theoretical pressure signal SPTD and determines, as an output, the control signal SC1. The control signal SC1 is defined based on the desired theoretical pressure signal SPTD and filtered from possible oscillations indicated by the filtering signal SF.

Furthermore, the winch control device 13a comprises a calculation unit 34, which receives, as an input, the measured travel speed signal S2, the wound rope length signal S7, the measured angle signal S5, the measured pressure signal PF and provides, as an output, a desired theoretical displacement signal SCTD calculated based on the input signals.

In certain embodiments, the calculation unit 34 receives, as in input, the engine revolution signal S6 and defines the desired theoretical displacement signal SCTD in addition to the signals listed above.

The winch control device 13a comprises a frequency-adjustable active filter 35 connected to the oscillation detector 33. The active filter 35 is frequency-adjusted based on the frequency or on the frequencies detected by the oscillation detector 33 so as to dampen or eliminate oscillations in the measured pressure PF or in the calculated pull force FFC.

The active filter 35 receives, as an input, the desired theoretical displacement signal SCTD and the filtering signal SF and determines a filtered desired theoretical displacement signal SCTDF. The filtered desired theoretical displacement signal SCTDF is determined based on the desired theoretical displacement signal SCTD and filtered from the oscillation indicated in the filtering signal SF.

The winch control device 13a comprises a calculation unit 36, which receives, as an input, the filtered desired theoretical displacement signal SCTDF, the filtering signal SF, the calculated pull force signal FFC and the desired theoretical force signal SFTD and defines, as an output, the second control signal SC2 based on the input signals.

Furthermore, the vehicle control unit 13 is configured to define a forward command signal DDC based on the engine revolution number signal S6, on the wound rope length signal S7, on the measured pressure signal PF and on the filtering signal SF.

In more detail, the vehicle control unit 13 is connected to the winch control device 13a so as to define the forward command signal DDC.

In more detail, the vehicle control unit 13 comprises a processing unit 13b and a processing unit 13c. The processing unit 13b receives, as an input, the engine revolution number signal S6, the wound rope length signal S7, the measured pressure signal PF and determines a speed limit signal VSL initiating the maximum speed that can be reached by the tracked vehicle 1. The processing unit 13c is connected to the processing unit 13b and receives, as an input, the speed limit signal VSL and the filtering signal SF and defines the forward command signal DDC, which causes the snow groomer 1 to move forward. In particular, the forward command signal DDC can control the tracks of the snow groomer so as to define the forward movement of the snow groomer 1.

According to the present disclosure, the control signal SC1 adjusts the pull force of the winch assembly 10 by a control consisting of an electronic open-loop control relating to the pull force, connected in series to a feedback hydraulic control on the pressure of the hydraulic circuit 20. The electronic open-loop control is relatively stable and insensitive to internal and external disturbances and/or to control variations and/or to load variations based on the adjustable active filtering and to the oscillation detector.

Furthermore, in the embodiment in which the control signal SC2 is adjusted based on the inputs, the pull force and the pull speed are adjusted in an independent manner and by two electronic controls, which are in series to the feedback hydraulic control. This type of control ensures the advantages discussed above, in addition to the advantage of having a relatively very precise and stable control on the pull force and on the pull speed, even for relatively high values and even for relatively quick dynamics due to sudden load changes. Moreover, this type of control reduces consumptions.

Furthermore, the disclosure evidently also covers embodiments that are not described in the detailed description above as well as equivalent embodiments that are part of the scope of protection set forth in the appended claims. Accordingly, various changes and modifications to the presently disclosed embodiments will be apparent to those skilled in the art.

The invention claimed is:

1. A winch assembly comprising:
a support structure;
a drum rotatable relative to the support structure;
a cable wrapped around the drum;
an actuator assembly coupled to the drum and configured to receive at least one of: a first control signal indicative of a desired pump pressure of the actuator assembly, and a second control signal indicative of a desired pump displacement of the actuator assembly; and
a winch control device coupled to the actuator assembly and configured to:
control, via the actuator assembly, a winding and an unwinding of the cable, and
determine at least one of the first control signal and the second control signal based on at least one of: a measured travel speed signal indicating a measured travel speed of a tracked vehicle, a measured pressure signal indicative of a measured pressure of a high pressure branch of a hydraulic circuit of the actuator assembly, and at least one signal of: a cable speed signal, a wound cable length signal, an operator set desired pull force signal, a measured angle signal of an arm of the winch assembly relative to a forward direction, and a calculated pull force signal indicating a calculated pull force.

2. The winch assembly of claim 1, wherein the winch control device is configured to determine at least one of the first control signal and the second control signal based on a pressure of at least one pump of at least one track of the tracked vehicle and a pressure difference between two pumps of two tracks of the tracked vehicle.

3. The winch assembly of claim 1, wherein the winch control device further comprises:
an oscillation detector configured to:
receive, as an input, the calculated pull force signal,
detect oscillations by detecting frequencies related to harmonics having amplitude values greater than a certain value, and
output at least one frequency value if an oscillation on the calculated pull force signal is detected, and
an active filter that is frequency-adjustable and adjusted in frequency based on the frequency detected by the oscillation detector to at least dampen oscillations in the calculated pull force, wherein the winch control device is configured to define the first control signal via the active filter.

4. The winch assembly of claim 1, wherein the winch control device is configured to determine the first control signal based on at least one of: the measured angle signal, the cable speed signal, the wound cable length signal, the measured travel speed signal, the calculated pull force signal, the operator set desired pull force signal, and the measured pressure signal.

5. The winch assembly of claim 1, wherein the winch control device is configured to determine the first control signal based on at least one of a value of at least one pressure of at least one pump supplying at least one of a first track of the tracked vehicle and a second track of the tracked vehicle, and a track pressure signal indicative of a pressure difference of the hydraulic circuits supplying the first track of the tracked vehicle and the second track of the tracked vehicle.

6. The winch assembly of claim 1, wherein the winch control device is configured to determine the second control signal based on at least one of: the measured angle signal, the cable speed signal, the wound cable length signal, the operator set desired force signal, the calculated pull force signal, the measured travel speed signal, and the measured pressure signal.

7. The winch assembly of claim 1, wherein the winch control device is configured to determine the second control signal based on at least one of: a motor unit speed signal and a track pressure signal.

8. The winch assembly of claim 1, wherein the winch control device is configured to determine the second control signal based on a desired theoretical force signal calculated based on at least one of: the measured angle signal, the cable speed signal, the desired pull force signal, a track pressure signal and the measured travel speed signal.

9. The winch assembly of claim 1, further comprising
an oscillation detector configured to:
receive, as input, the calculated pull force signal,
detect oscillations by detecting frequencies related to harmonics having amplitude values greater than a certain value, and
provide, as output, at least one frequency value if an oscillation on the calculated pull force signal is detected, and
an active filter that is frequency-adjustable based on the frequency detected by the oscillation detector to at least dampen oscillations in the calculated pull force, wherein the winch control device is configured to determine the second control signal via the active filter.

10. The winch assembly of claim 1, wherein the actuator assembly comprises:
a hydraulic circuit, and
a variable displacement pump which supplies the hydraulic circuit and is configured to vary a displacement based on a pressure defined by at least one of: the pressure of the high pressure branch of the hydraulic circuit, a pressure indicated by the first control signal, and the second control signal.

11. The winch assembly of claim 10, further comprising a variable displacement hydraulic motor coupled to the hydraulic circuit and supplied by the variable displacement pump via the hydraulic circuit, the variable displacement hydraulic motor configured to vary a displacement based on the pressure of the high pressure branch of the hydraulic circuit.

12. The winch assembly of claim 1, wherein the winch control device comprises a control unit configured to receive, as input, the wound cable length signal and the measured pressure signal and output a calculated pull force signal indicative of an estimated pull force on the cable.

13. The winch assembly of claim 1, wherein the control device is independent of a force sensor configured to measure the pull force on the cable.

14. A tracked vehicle comprising:
an engine assembly;
a first track;
a second track; and
a winch assembly comprising:
a support structure,
a drum rotatable relative to the support structure,
a cable wrapped around the drum,
an actuator assembly coupled to the drum and configured to receive at least one of: a first control signal indicative of a desired pump pressure of the actuator assembly, and a second control signal indicative of a desired pump displacement of the actuator assembly, and
a winch control device coupled to the actuator assembly and configured to:
control, via the actuator assembly, a winding and an unwinding of the cable, and
determine at least one of the first control signal and the second control signal based on at least one of: a measured travel speed signal indicating a measured travel speed of the tracked vehicle, a measured pressure signal indicative of a measured pressure of a high pressure branch of a hydraulic circuit of the actuator assembly, and at least one signal of: a cable speed signal, a wound cable length signal, an operator set desired pull force signal, a measured angle signal of an arm of the winch assembly relative to a forward direction, and a calculated pull force signal indicating a calculated pull force.

15. The tracked vehicle of claim 14, comprising a first pump configured to drive the first track and a second pump configured to drive the second track.

16. The tracked vehicle of claim 14, further comprising a vehicle control unit connected to the winch control device and configured to define a forward command signal.

17. A method of controlling a winch assembly of a tracked vehicle, the winch assembly comprising a rotatable drum, a cable wrapped around the drum, an actuator assembly coupled to the drum, comprising a variable displacement pump and a hydraulic motor and configured to wind and unwind the cable, the method comprising:
controlling the pressure exiting the variable displacement pump to control at least one of the winding and unwinding of the cable and the displacement of the variable displacement pump to control the winding and unwinding of the cable based on the measured travel speed of the tracked vehicle, a pressure value measured on a high pressure branch of a hydraulic circuit of the actuator assembly, and at least one value of: a cable speed, a wound cable length, an operator set desired pull force, and a measured angle of the arm of the winch assembly relative to a direction of travel.
